(19) United States
(12) Patent Application Publication
(10) Pub. No.: US 2006/0156321 A1
(43) Pub. Date: Jul. 13, 2006

(54) Electronic equipment

(75) Inventor: Yoshiro Tanaka, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/132,422

(22) Filed: May 19, 2005

(30) Foreign Application Priority Data
Jan. 7, 2005 (JP) 2005-003021

(51) Int. Cl. G11B 33/14

(52) U.S. Cl. 720/650

(57) ABSTRACT

When a flexible printed circuit is not connected to a connector pin of a hard disk contained in a notebook PC, and a substrate face of the hard disk faces a ground side (horizontal coupling plate side), substantially the entire substrate face of the hard disk is covered with a Π-shaped shielding material.

### BACKGROUND OF THE INVENTION

1. Field of the Invention

The present invention relates to electronic equipment including a hard disk, and more specifically to electronic equipment having maintained and improved electrostatic discharge trouble tolerance of a built-in hard disk.

2. Description of the Related Art

Recently, in guaranteeing the quality of electronic equipment, the importance of countermeasures against electrostatic discharge has attracted attention. In the countermeasures against electrostatic discharge of electronic equipment, it is important to protect the electronic equipment against the damage from the electrostatic discharge to enhance the reliability of a product. A typical product of electronic equipment is a personal computer (PC) Personal computers are roughly classified into notebook PCs and desktop PCs, and notebook PCs have become predominant. Most personal computers include a hard disk (HDD: hard disk drive unit) as a storage device.

The entire enclosure of a desktop PC is covered with metal which functions as a shield, but the enclosure of a notebook PC is plastic, and the entire device is not shielded with metal. Furthermore, the frame ground (FG) of a notebook PC is not so strong as that of a desktop PC. Therefore, a notebook PC is not so resistant to external electrostatic discharge as a desktop PC because the plastic enclosure of a notebook PC passes the electromagnetic wave emitted by the electrostatic discharge, thereby failing in shielding the electromagnetic wave invading the device from outside. Therefore, countermeasures against the electrostatic discharge (hereinafter referred to as ESD) to the built-in parts and units are more important for a notebook PC than for a desktop PC. The source of the ESD is mainly a human body, and the ESD invades a notebook PC through the unshielded enclosure. The operation frequency (clock frequency) of the CPU of a notebook PC increases year by year, and has reached nearly 2 GHz recently. Additionally, it has become thinner and lighter in weight, and the parts and units configuring a notebook PC have been implemented with high density on the printedboard (printed substrate). Furthermore, for lower power consumption, the operation voltage of the CPU has been reduced corresponding to the enhancement of the operation frequency. The operation voltages of the parts and units have also been dropped.

The units and parts of the CPU, etc. of a notebook PC are configured by a semiconductor device, etc., but a semiconductor device has been designed as a microstructure at a request in the market for a higher-density and speedy device. Therefore, the higher-density and microstructure have reduced the ESD tolerance of a semiconductor device. As a result, a semiconductor device can hardly maintain the conventional ESD tolerance. Under the above-mentioned circumstances, the electrostatic discharge tolerance (hereinafter referred to as ESD tolerance) of the HDD which is a main unit contained in a notebook PC has also been reduced.

The electronic parts subject to damage by the ESD are called an electrostatic sensitive device or an electrostatic discharge sensitive device. The HDD is one of such devices.

The HDD contained in a notebook PC is implemented on the printed board of a notebook PC. A printed board of the HDD including a ground layer is formed on one surface of the HDD, and a frame ground (FG) is formed on the other surface. The FG is provided to prevent the danger to a human body, and to shield the device. On the other hand, the ground layer of the printed board of the HDD is normally called a signal ground (SG), and is a potential reference point of the circuit inside the device.

An HDD is configured by a magnetic disk which is a storage medium, a motor, a magnetic head, a control circuit for them, a signal processing circuit for conversion of an analog signal to a digital signal, a hard disk controller, an interface with an external units, etc. The components of the hard disk include an IC configured by a semiconductor device. As described above, since the ESD tolerance of a storage device has become lower, the ESD tolerance of the IC has also become lower correspondingly.

The HDD contained in a notebook PC is an important unit of a notebook PC storing basic software, important data, etc. When the HDD is subject to damage by ESD, the notebook PC possibly stops its operation, and in the worst case, the notebook PC cannot be activated although it is powered up again, thereby possibly causing a fatal error.

The HDD trouble by ESD can be a recoverable error or an irrecoverable error. In the case of an irrecoverable error, it is necessary to exchange the HDD itself. When an irrecoverable error occurs, it is necessary to exchange the HDD itself.

Thus, an HDD plays an important role in a notebook PC, and the countermeasures against ESD of the built-in HDD are important to enhance the reliability of a notebook PC. However, at present, it is not certain from where the ESD attacks the built-in HDD. Therefore, the entire HDD has been conventionally stored in a long box shaped shielding enclosure to provide the entire HDD with the countermeasures of protecting the entire HDD against ESD. The shielding enclosure can be normally an aluminum case.

Aside from the objective of the present invention, as an example of a hard disk contained in a notebook PC, the configuration of an electronic device having a high shockproof hard disk by containing the hard disk in a enclosure has been published (Japanese Published Patent Application No. 2003-281877).

As described above, the conventional notebook PC protects the built-in HDD against ESD by containing the entire built-in HDD in a long box shaped shielded enclosure (mainly an aluminum case). However, the countermeasures against ESD using the shielded enclosure require a high material cost (85 yen after a trial calculation) and an assembly cost. Therefore, the problem of these costs has been the bottleneck in reducing the production cost of the notebook PC. Additionally, the thick and heavy structure of the shielded enclosure has also been the problem in realizing a lighter and thinner notebook PC.

### SUMMARY OF THE INVENTION

The present invention aims at realizing electronic equipment having a shielded structure capable of maintaining and improving the ESD tolerance of a built-in HDD without requiring an increase in production cost or without interfering with realization of a lighter and thinner notebook PC in producing electronic equipment containing a hard disk (HDD).

The present invention is based on electronic equipment containing a hard disk.

The first aspect of the present invention includes a substrate face of the hard disk provided on a ground side (for example, on a horizontal coupling plate side in an ESD simulator), and a shielding material for shielding the substrate face of the hard disk.

In the above-mentioned first aspect, for example, a connector of the hard disk can be configured as having no connection to a flexible printed circuit. There can be a flexible printed circuit connected to a connector of the hard disk and provided on the frame ground side of the hard disk. Furthermore, a printed board can be provided directly above the substrate face of the hard disk.

The second aspect of the present invention is based on the first aspect, and includes a flexible printed circuit connected to the connector of the hard disk and provided on the substrate face side of the hard disk.

In the second aspect, for example, the ground layer of the flexible printed circuit can be provided on the ground side and the substrate face of the hard disk can be covered with the flexible printed circuit and the shielding material.

The third aspect of the present invention is based on the first aspect, and includes a flexible printed circuit connected to a connector of the hard disk and a printed board provided directly above the substrate face of the hard disk.

In the third aspect, the flexible printed circuit can be provided on the substrate face side of the hard disk, the ground layer of the flexible printed circuit can be provided on the ground side, and the substrate face of the hard disk can be covered with the ground layer and the shielding material of the flexible printed circuit. Furthermore, for example, the flexible printed circuit can be provided on the frame ground surface side of the hard disk, the ground layer of the flexible printed circuit can be provided opposite the ground side, and the substrate face of the hard disk can be covered with the shielding material.

The fourth aspect of the present invention can include a printed board (for example, the main substrate of a notebook PC, etc.) provided directly above the substrate face of the hard disk, the frame ground face of the hard disk provided opposite the ground side, and a shielding material for shielding the substrate face of the hard disk.

In the fourth aspect, for example, a flexible printed circuit can be connected to the connector of the hard disk and can include a flexible printed circuit provided on the substrate face side of the hard disk, the ground layer of the flexible printed circuit can face the opposite direction of the ground side, and the substrate face of the hard disk can be covered with the ground layer of the flexible printed circuit and the shielding material. Furthermore, for example, a flexible printed circuit can be connected to the connector of the hard disk, and provided on the frame ground side of the hard disk, and the ground layer of the flexible printed circuit can be provided on the ground side.

According to the present invention, the electronic equipment containing a hard disk can maintain and improve the ESD tolerance of the built-in hard disk without increasing the cost of the electronic equipment or without interfering with realization of a lighter and smaller device. Furthermore, the production cost of the electronic equipment can be lower than in the conventional technology.

### BRIEF DESCRIPTION OF THE INVENTION

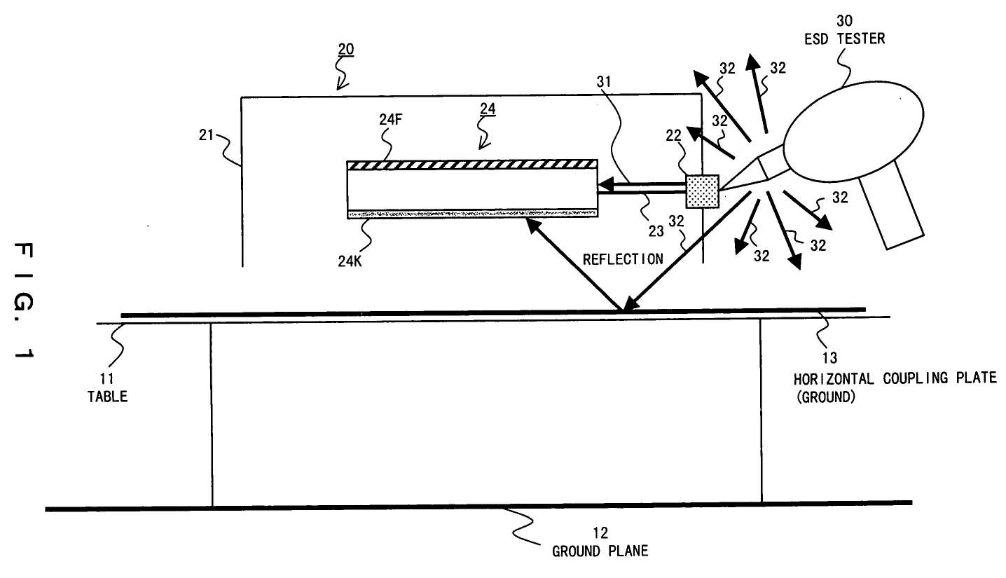

FIG. 1 shows the test configuration of an ESD immunity test;

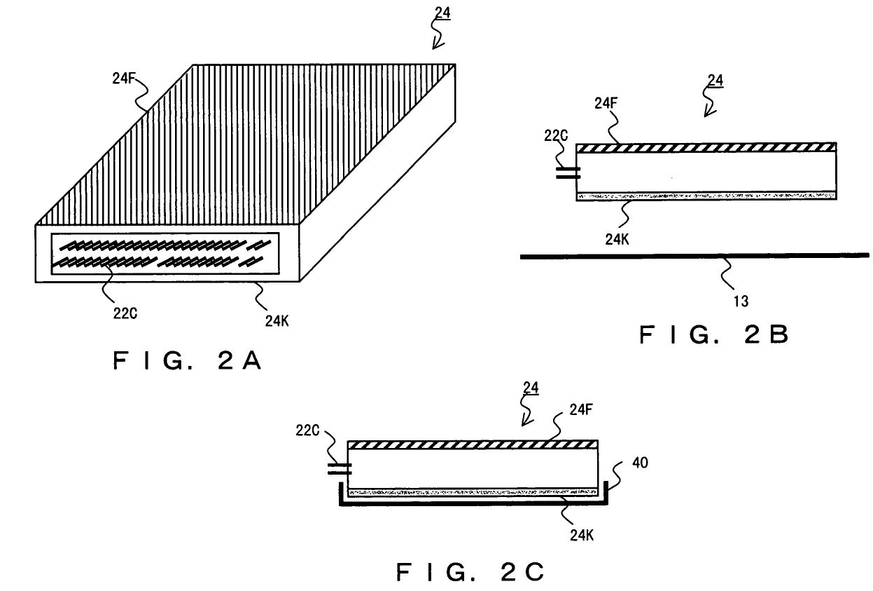

FIGS. 2A to 2C show the first shielding configuration of the HDD not equipping its connector with a flexible printed circuit;

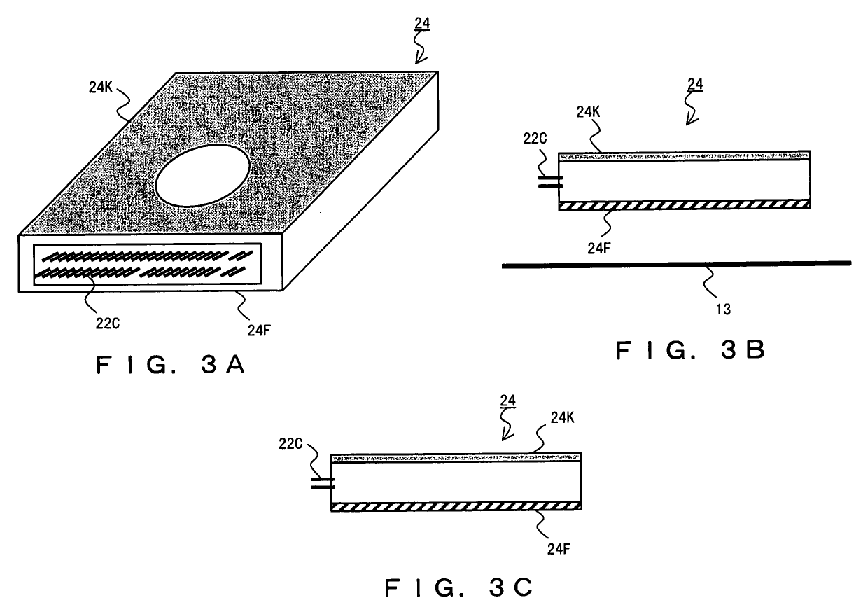

FIGS. 3A to 3C show the configuration not requiring a shield in the HDD not equipping its connector with a flexible printed circuit;

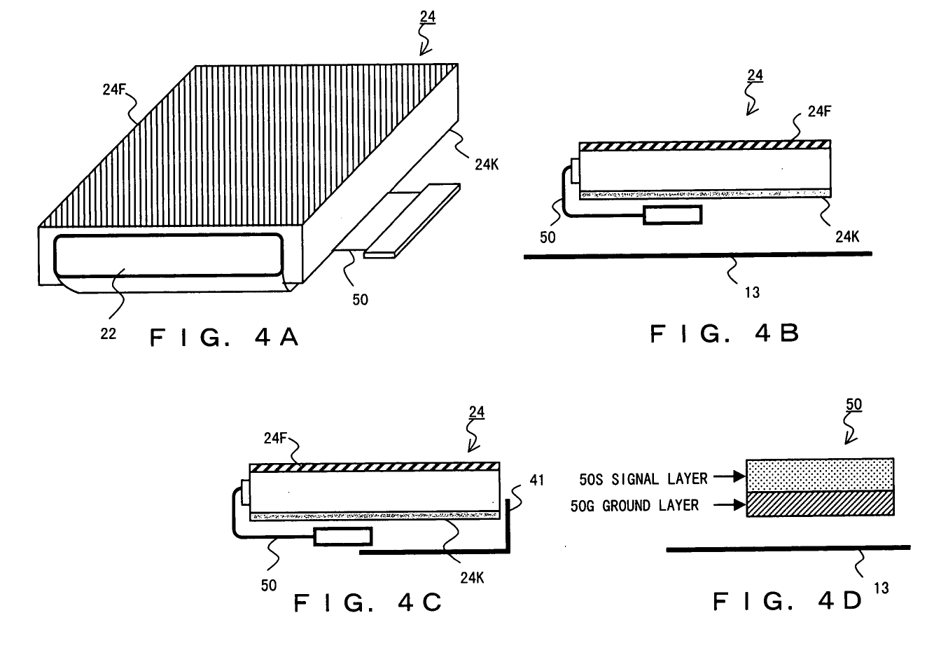

FIGS. 4A to 4D show the first shielding configuration of the HDD equipping its connector with a flexible printed circuit;

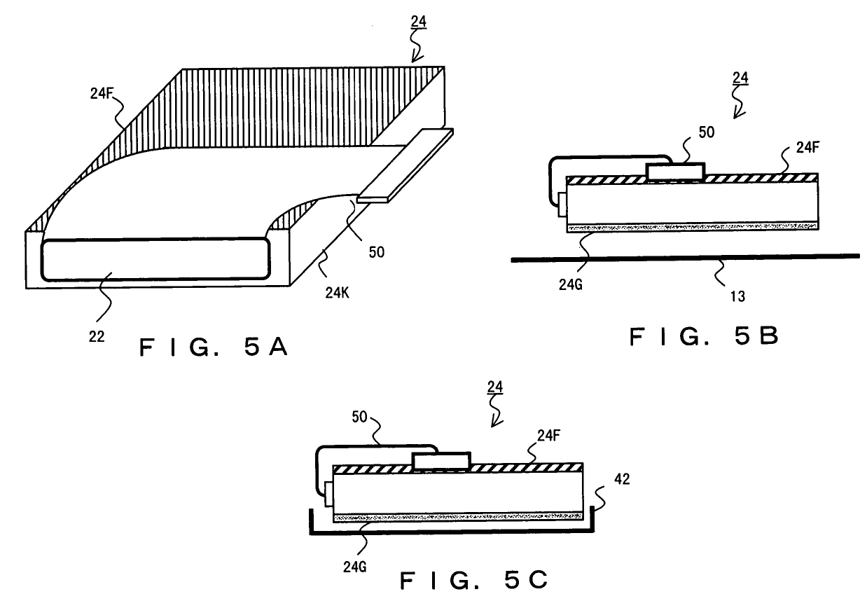

FIGS. 5A to 5C show the second shielding configuration of the HDD equipping its connector with a flexible printed circuit;

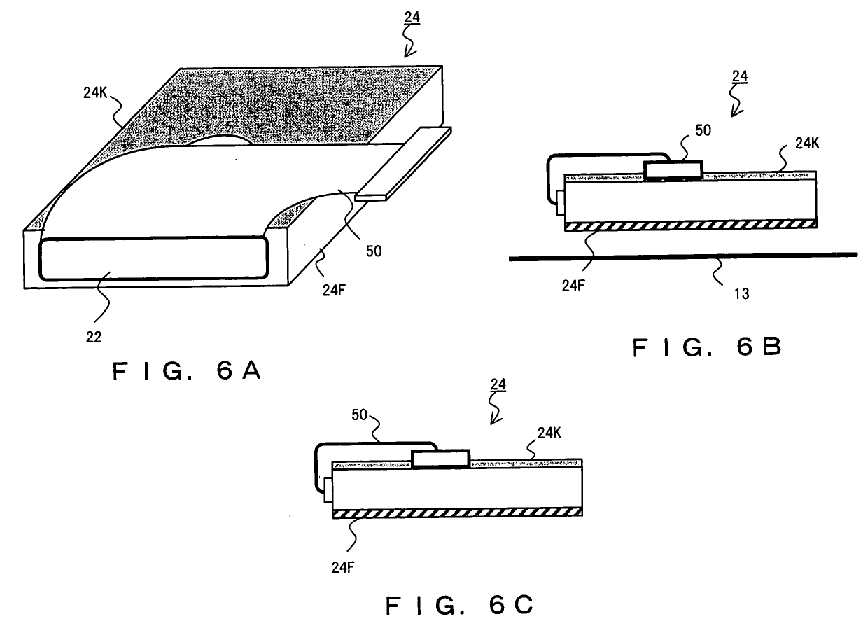

FIGS. 6A to 6C show the first configuration not requiring a shield in the HDD equipping its connector with a flexible printed circuit;

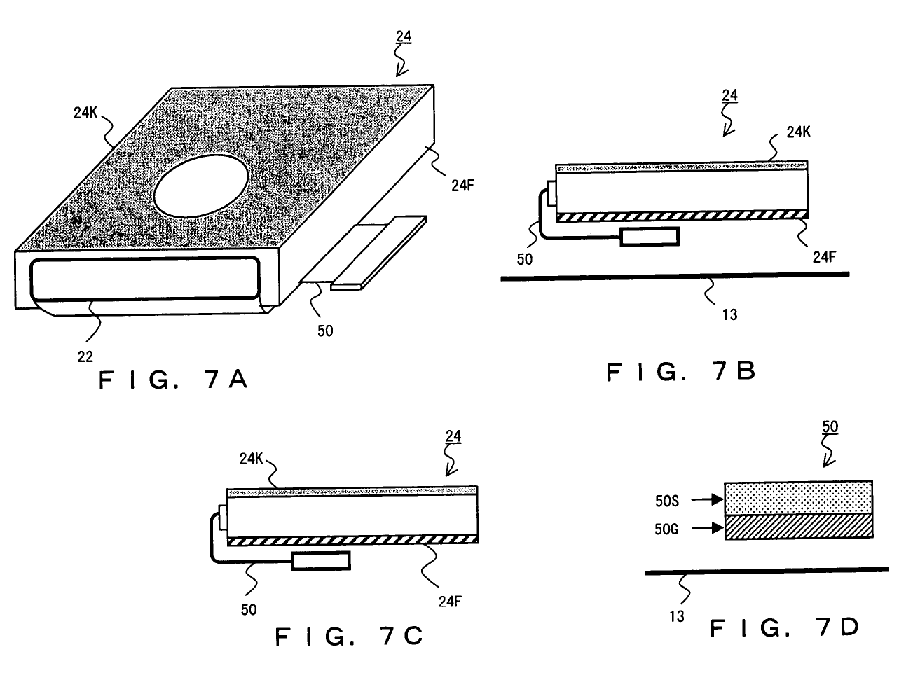

FIGS. 7A to 7D show the second configuration not requiring a shield in the HDD equipping its connector with a flexible printed circuit;

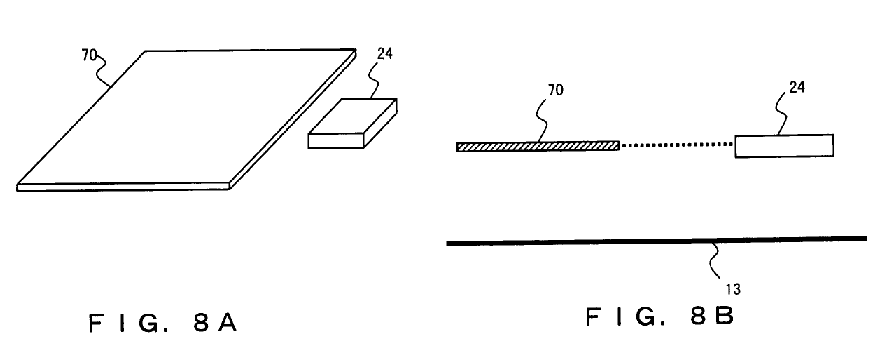

FIGS. 8A and 8B show the configuration in which the HDD is at the same level as the printed board of a notebook PC, FIG. 8A is a perspective view, and FIG. 8B is a sectional view;

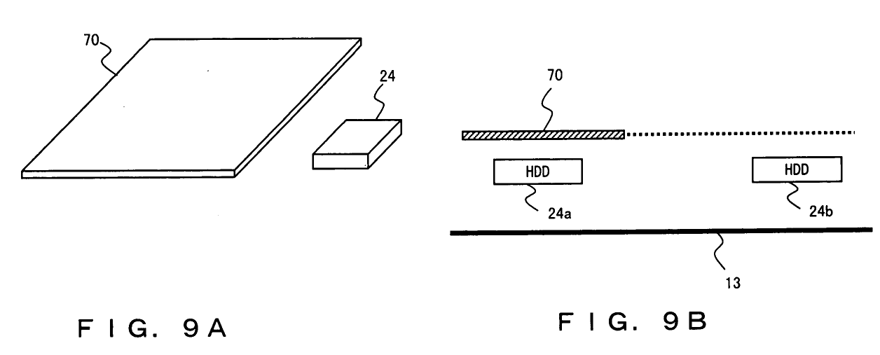

FIGS. 9A and 9B show the configuration in which the HDD is at a level lower than the printed board of a notebook PC, FIG. 9A is a perspective view, and FIG. 9B is a sectional view;

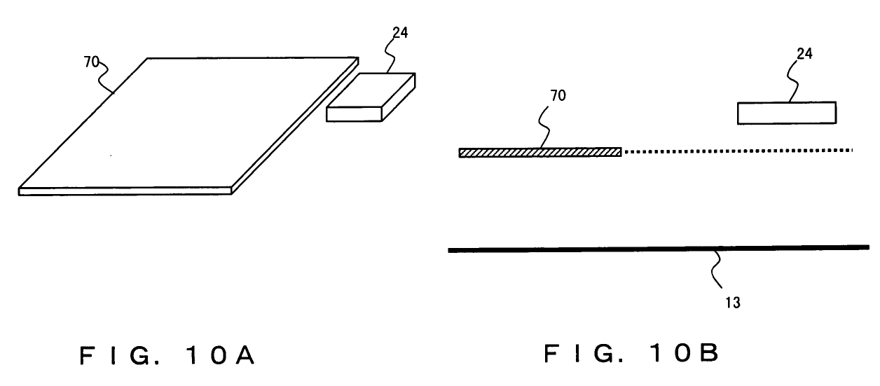

FIGS. 10A and 10B show the configuration in which the HDD is at a level higher than the printed board of a notebook PC, but the lower face of the HDD is not completely covered with the printed board of the notebook PC, FIG. 10A is a perspective view, and FIG. 10B is a sectional view;

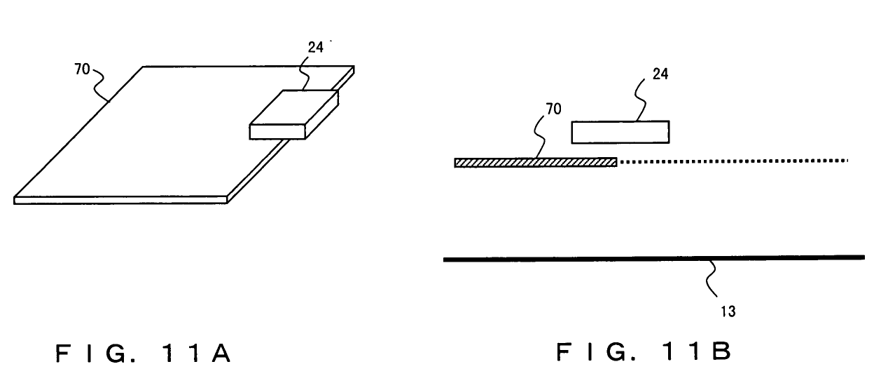

FIGS. 11A and 11B show the configuration in which the HDD is at a level higher than the printed board of a notebook PC, but the lower face of the HDD is not sufficiently covered with the printed board of the notebook PC, FIG. 11A is a perspective view, and FIG. 11B is a sectional view;

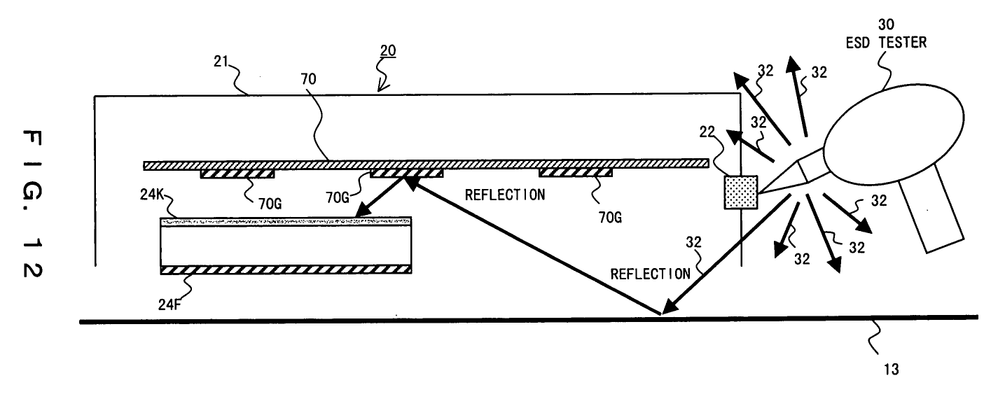

FIG. 12 shows an ESD immunity test when radiation noise generated by an ESD simulator is sequentially reflected by the ground of the table and the ground of the surface layer of the printed board of a notebook PC, and affects the substrate face of the HDD;

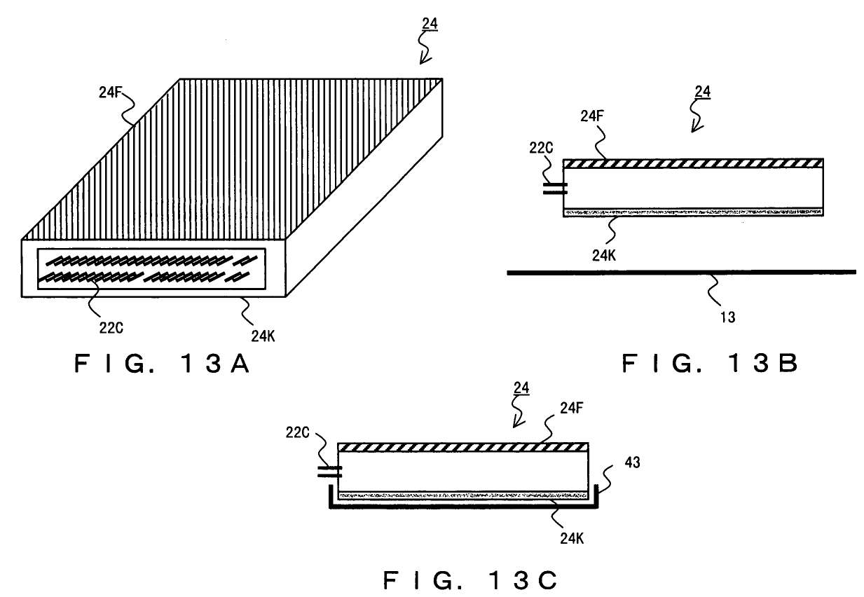

FIGS. 13A to 13C show the first shielding configuration when the reflection of the radiation noise by the ground of the substrate face of the printed board of a notebook PC is taken into account in the HDD using a flexible printed circuit for a connector;

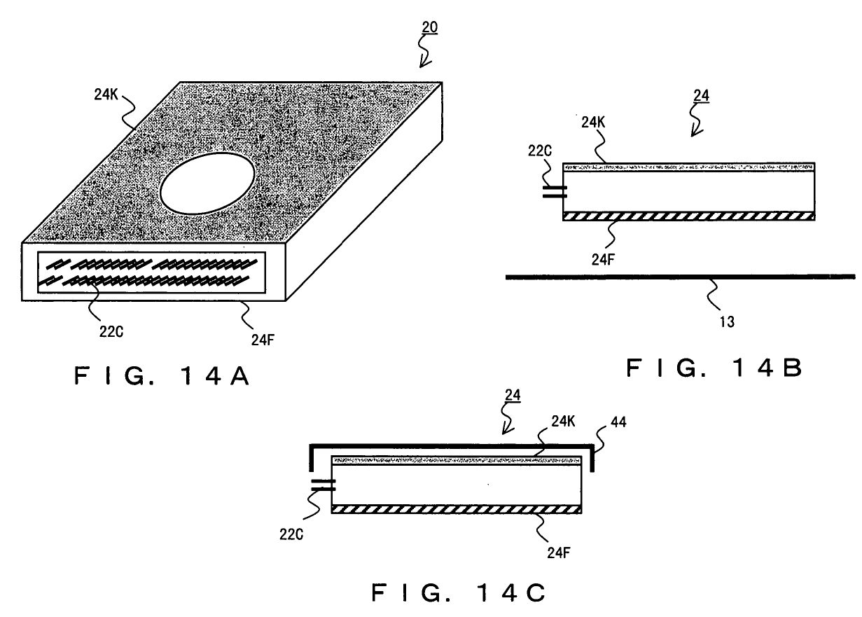

FIGS. 14A to 14C show the second shielding configuration when the reflection of the radiation noise by the ground of the substrate face of the printed board of a notebook PC is taken into account in the HDD using a flexible printed circuit for a connector;

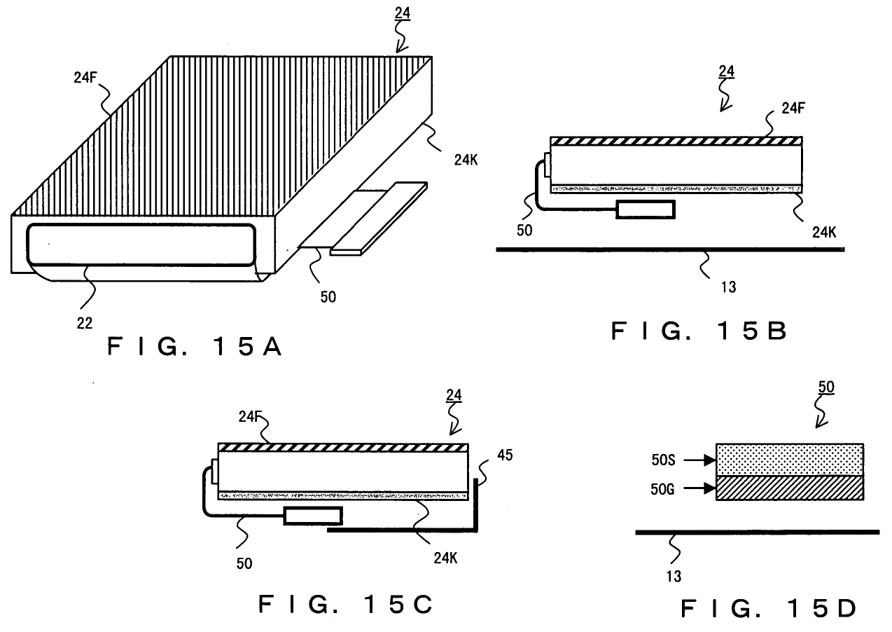

FIGS. 15A to 15D show the third shielding configuration when the reflection of the radiation noise by the ground of the substrate face of the printed board of a notebook PC is taken into account in the HDD using a flexible printed circuit for a connector;

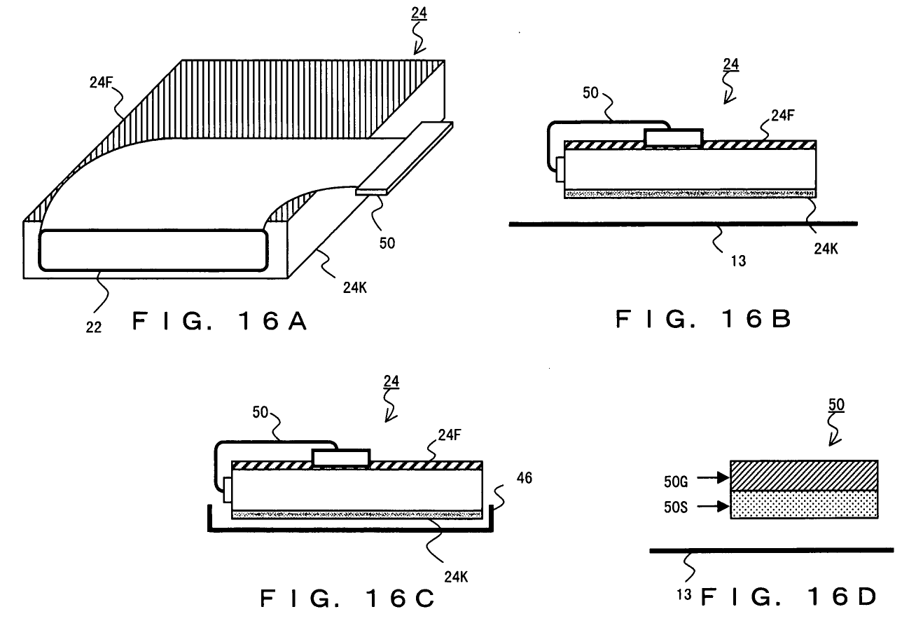

FIGS. 16A to 16D show the fourth shielding configuration when the reflection of the radiation noise by the ground of the substrate face of the printed board of a notebook PC is taken into account in the HDD using a flexible printed circuit for a connector;

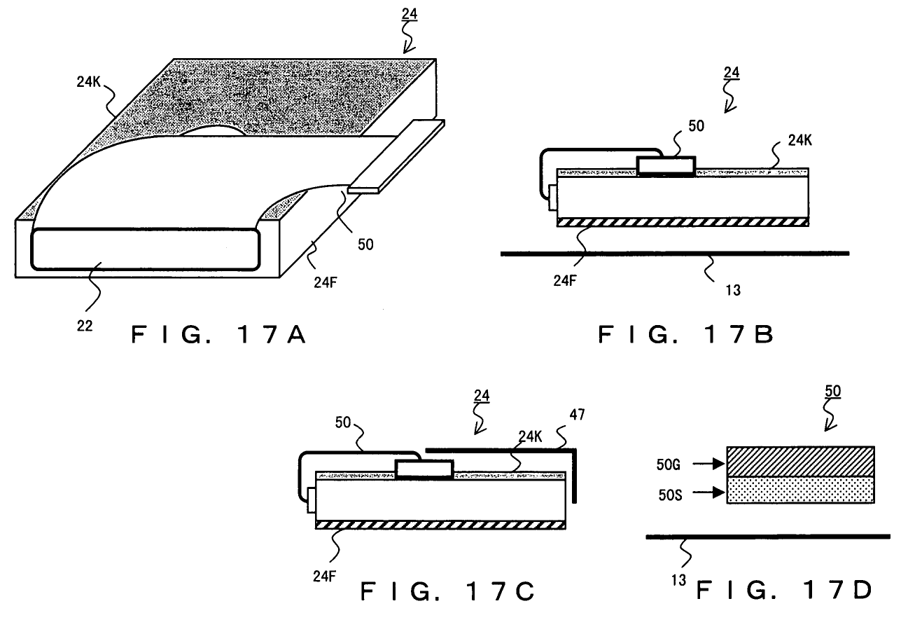

FIGS. 17A to 17D show the fifth shielding configuration when the reflection of the radiation noise by the ground of the substrate face of the printed board of a notebook PC is taken into account in the HDD equipping its connector with a flexible printed circuit;

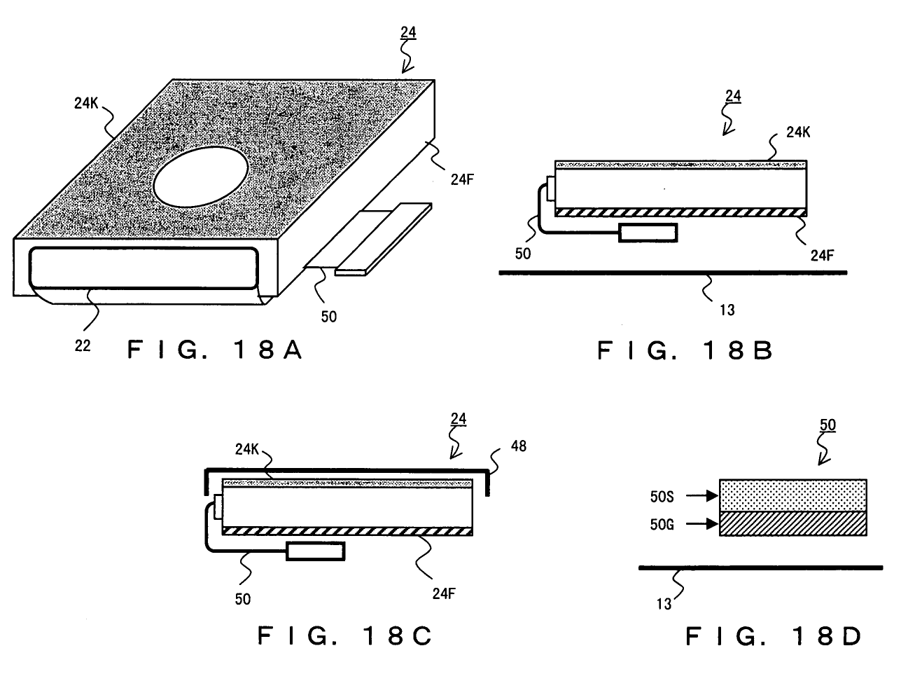

FIGS. 18A to 18D show the sixth shielding configuration when the reflection of the radiation noise by the ground of the substrate face of the printed board of a notebook PC is taken into account in the HDD equipping its connector with a flexible printed circuit; and

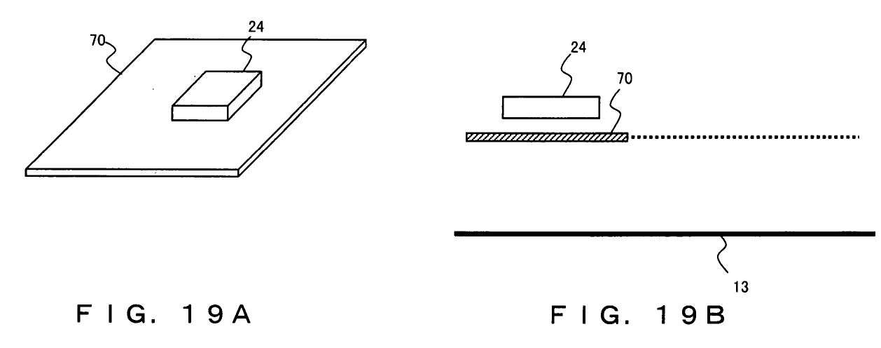

FIGS. 19A and 19B show the configuration in which the HDD is at a level higher than the printed board of a notebook PC, and the lower face of the HDD is completely covered with the printed board of the notebook PC, FIG. 19A is a perspective view, and FIG. 19B is a sectional view.

### DETAILED DESCRIPTION OF THE INVENTION

The embodiments of the present invention are described below by referring to the attached drawings.

The noise by the ESD can be radiation noise and conductive noise. The radiation noise propagates in spaces, and is composed of an electromagnetic field (electromagnetic wave) generated by an electrostatic field effect and an electromagnetic field generated by a discharged current. The conductive noise propagates via wiring, and can be an induced current generated by a direct charge injection and an electromagnetic field. The static electricity is generated by the friction between a person or an article (a metal chair, a hand truck, etc.) and the floor, and is accumulated in the person or the article. The accumulated static electricity is discharged by contact with equipment. The ESD (electrostatic discharge) causes a malfunction or damage to equipment as noise, thereby intermittently causing unaccounted trouble to the equipment.

The Applicant conducted an ESD test on the built-in HDD of a notebook PC based on the standard (CISPR24) relating to the ESD. As a result, relating to a built-in HDD, it has been judged that the radiation noise, especially the radiation noise reflected by the ground (horizontal coupling plate in the ESD immunity test), has a larger influence on the reverse side of a device than the conductive noise.

The CISPR24 is regulated by the CISPR (International Special Committee on Radio Interference) to suppress a malfunction and damage of information technology equipment (ITE) by the ESD. The CISPR24 regulates that “A device to be tested is to normally operate when an operator applies a predetermined test voltage to all targets that the operator can touch”. It also regulates relating to the information technology equipment as “having a raged power voltage of 600 V or less, having each or a combination of facilities of input, storage, display, retrieval, transmission, process, exchange, or control of data and telecommunication messages, and having one or a number of terminal ports operating typically for information transmission”.

FIG. 1 shows a conduct environment of the ESD test (ESD tolerance test) performed by the Applicant on the notebook PC.

As shown in FIG. 1, a table 11 is placed on a ground plane 12, and a horizontal coupling plate (ground) 13 is laid on the surface of the table 11. The ground plane 12 is provided to suppress charging when a person or a hand truck transfers. The horizontal coupling plate 13 is provided to suppress sudden ESD of the metal table 11. Then, a notebook PC 20 is placed on the horizontal coupling plate 13, and the ESD is applied from an ESD simulator 30 to a connector 22 provided on the side of a enclosure 21 of the notebook PC 20. The connector 22 is connected to an HDD 24 in the notebook PC 20 through a wiring 23.

One face of the HDD 24 is an FG face 24F on which an FG is formed, and the other face is a substrate face 24K. The substrate face 24K is an uncovered surface of the printed substrate on which the HDD 24 is implemented. The ESD simulator 30 has a configuration in which the electrostatic capacity (100 pF˜500 pF) of a human body and the resistance (100 Ω˜1 kΩ) of a human body are taken into account.

In the test, the ESD simulator 30 contacts the connector 22, and a test voltage is applied from the ESD simulator 30. Thus, in FIG. 1, conductive noise 31 and radiation noise 32 indicated by arrows shown in FIG. 1 are generated. The conductive noise 31 propagates to the HDD 24 through the wiring 23. On the other hand, the radiation noise 32 radiantly propagates in spaces, but a part of the noise passes through the enclosure 21 invades the inside of the notebook PC 20, and other radiation noise 32 is reflected by the horizontal coupling plate 13 and propagates to the HDD 24 through the bottom, etc. of the notebook PC 20.

As a result of conducting the above-mentioned test on the notebook PC of a company A and the notebook PC of a company B, it is judged from both of the PCs that the influence on the notebook PC of the radiation noise 32, especially reflected by the horizontal coupling plate and input into the reverse side of the notebook PC 20, is larger than that of the conductive noise 32. Furthermore, as a result of conducting the test on a shielded substrate face 24K and an unshielded substrate face 24K of the HDD 24, the difference between them in ESD tolerance is about 3 kV (using the notebook PC of the F company). The difference in ESD tolerance depends on the arrangement and the type of HDD in the notebook PC.

As a result, when the FG face 24F of the HDD 24 faces the ground side (face of the horizontal coupling plate 13), the HDD 24 requires no shield. However, when the substrate face 24K of the HDD 24 faces the ground side, a shield is required.

When a flexible printed circuit (FPC) is connected to the connector 22 of the HDD 24, and the ground layer of the flexible printed circuit is arranged as facing the ground side, the flexible printed circuit can be used as a part of the shield of the HDD 24.

The arrangement in implementing the HDD 24 on the notebook PC 20 is classified by the following combinations of (1) and (2), it is determined whether or not it is necessary to apply a shield in each arrangement. If a shield is required, the actual shield configuration is devised.
(1) Presence/absence of a flexible printed circuit connected to the connector of the HDD (presence/absence of a flexible printed circuit)
(2) Whether or not the substrate face of the HDD faces the ground side, or whether or not the FG face of the HDD faces the ground side
   [Shield Configuration (I) of HDD]
1) When there is no flexible printed circuit:
a) When the substrate face of the HDD faces the ground side:

FIG. 2 is a schematic chart showing the shield configuration in the arrangement when there is no flexible printed circuit, and the substrate face of the HDD faces the ground side. In FIG. 2, the lower portion of the figure refers to the ground side, and the same holds true with the subsequent figures.

FIGS. 2A and 2B are the perspective view and the sectional view of the above-mentioned arrangement. FIG. 2 also shows a connector pin 22C of the connector 22 provided on the front side of the HDD 24.

As shown in FIGS. 2A and 2B, a shield is required when the substrate face 24K of the HDD 24 faces the ground side (side of the horizontal coupling plate 13). Therefore, as shown in FIG. 2C, a Π-shaped shielding material 40 shields almost the entire substrate face 24K of the HDD 24. That is, the shielding material 40 is arranged to cover the bottom of the HDD 24 and the lower portions of the left and right sides of the HDD 24.
b) When the FG face of the HDD faces the ground side:

FIG. 3 is an explanatory view showing the shield configuration in the arrangement in which there is no flexible printed circuit, and the FG face of the HDD faces the ground side. FIGS. 3A and 3B are respectively a perspective view and a sectional view. In this arrangement, as shown in FIG. 3C, the shield of the substrate face 24K of the HDD 24 is not required.
2) When there is a flexible printed circuit:
a) When the substrate face of the HDD faces the ground side:
i) When the flexible printed circuit is on the substrate face side of the HDD:

FIG. 4 is an explanatory view showing the shield configuration in the arrangement in which there is a flexible printed circuit and the flexible printed circuit is on the substrate face side of the HDD, and the substrate face of the HDD faces the ground side.

FIGS. 4A and 4B are respectively a perspective view and the sectional view of the above-mentioned arrangement. As shown in FIGS. 4A and 4B, a flexible printed circuit 50 is bent in the longitudinal direction below the substrate face 24K of the HDD 24, and furthermore bent toward right side of the HDD 24 at the substantially central portion below the HDD 24. One end of the flexible printed circuit 50 runs over the bottom of the HDD 24 (FIG. 4A).

The flexible printed circuit 50 has a double layer configuration as shown in FIG. 4C, and is configured by a ground layer 50G and a signal layer 50S laid thereon.

In the case of the arrangement as shown in FIGS. 4A and 4B, it is necessary to shield the substrate face 24K of the HDD 24. However, since the flexible printed circuit 50 is below the bottom of the HDD 24, and the ground layer 50G of the flexible printed circuit 50 faces the ground side, as shown in FIG. 4C, to shield the portion not covered with the flexible printed circuit 50 in the substrate face 24K of the HDD 24, the side (the side not connected to the flexible printed circuit 50) of the HDD 24 and the bottom portion are shielded by an L-shaped shielding material 41. At this time, the end portions of the L-shaped shielding material 41 and the flexible printed circuit 50 are superposed. It is desired that the superposed portions are sufficiently reserved. In FIG. 4C, although the L-shaped shielding material 41 is arranged below the flexible printed circuit 50, the L-shaped shielding material 41 can be configured to be arranged above the flexible printed circuit 50. Furthermore, the L-shaped shielding material 41 and the flexible printed circuit 50 are arranged not to touch each other.
ii) When the flexible printed circuit 50 is on the FG face side 24F of the HDD 24:

FIG. 5 is an explanatory view showing the shield configuration in the arrangement in which there is a flexible printed circuit and the flexible printed circuit is on the FG face side of the HDD, and the substrate face of the HDD faces the ground side.

FIGS. 5A and 5B are respectively a perspective view and the sectional view of the above-mentioned arrangement. As shown in FIGS. 5A and 5B, the flexible printed circuit 50 is bent in the longitudinal direction above the FG face 24F of the HDD 24, and furthermore bent toward right side of the HDD 24 at the substantially central portion below the HDD 24. One end of the flexible printed circuit 50 runs over the top of the HDD 24 (FIG. 5A). The flexible printed circuit 50 has a double layer configuration as shown in FIG. 4D.

In this case, as shown in FIG. 5C, a Π-shaped shielding material 42 shields almost the entire substrate face 24K of the HDD 24. The arrangement configuration of the shielding material 42 is substantially the same as the case shown in FIG. 2C.
b) When the FG face of the HDD faces the ground side:
i) When the flexible printed circuit is on the substrate face side of the HDD:

FIG. 6 is an explanatory view showing the shield configuration in the arrangement in which there is a flexible printed circuit and the flexible printed circuit is on the substrate face side of the HDD, and the FG face of the HDD faces the ground side.

FIGS. 6A and 6B are respectively a perspective view and the sectional view of the above-mentioned arrangement. As shown in FIGS. 6A and 6B, the flexible printed circuit 50 is bent in the longitudinal direction above the substrate face side 24K of the HDD 24, and furthermore bent toward right side of the HDD 24 at the substantially central portion above the HDD 24. One end of the flexible printed circuit 50 runs over the top of the HDD 24 (FIG. 6A). The flexible printed circuit 50 has a double layer configuration as shown in FIG. 4D.

In this case, as shown in FIG. 6C, the shield of the substrate face 24K of the HDD 24 is not required.
ii) When the flexible printed circuit is on the FG face side of the HDD:

FIG. 7 is an explanatory view showing the shield configuration in the arrangement in which there is a flexible printed circuit and the flexible printed circuit is on the FG face side of the HDD, and the FG face of the HDD faces the ground side.

FIGS. 7A and 7B are respectively a perspective view and the sectional view of the above-mentioned arrangement. As shown in FIGS. 7A and 7B, the flexible printed circuit 50 is bent in the longitudinal direction below the FG face 24F of the HDD 24, and furthermore bent toward right side of the HDD 24 at the substantially central portion below the HDD 24. One end of the flexible printed circuit 50 runs over the bottom of the HDD 24 (FIG. 7A).

In this case, as shown in FIG. 7C, the shield of the substrate face 24K of the HDD 24 is not required. However, the flexible printed circuit 50 has the configuration in which the ground layer 50G of the flexible printed circuit 50 faces the land side (side of the horizontal coupling plate 13). The shield configuration described above sets the HDD unit as a target to protect the substrate face 24K of the HDD 24 against the radiation noise of an electromagnetic wave reflected by the ground. However, a notebook PC necessarily has a printed board for management of the functions of the notebook PC. Since the printed board necessarily includes a ground layer, a shield using the ground layer can be realized. In this case, since the ground layer of the printed board of a notebook PC shields the noise (electromagnetic wave) reflected by the ground. Therefore, it is not necessary to excessively shield the HDD.

The shield configuration in the above-mentioned cases is described below by referring to FIGS. 8 through 12.

[A]

FIGS. 8A through 11B are perspective and sectional views showing the first through fourth arrangements of the 70 and the HDD 24 of a notebook PC.

FIGS. 8A and 8B shows the configuration of the arrangement in which the HDD 24 is adjacent to the printed board 70 and arranged at substantially the same height level. FIGS. 9A and 9B shows the configuration in which the HDD 24 is arranged at a height level lower than the printed board 70. The arrangement configuration includes the cases in which the top surface of the HDD 24 is completely below the printed board 70 (HDD 24a), and in which the HDD 24 is adjacent to the printed board 70 of a notebook PC in the horizontal direction and is lower than the printed board 70 (HDD 24b). FIGS. 10A an 10B show the configuration in which the HDD 24 is at a level higher than the printed board 70 of a notebook PC, but the lower face of the HDD 24 is not completely covered with the printed board 70 of the notebook PC (the entire bottom of the HDD 24 is not above the printed board 70 of the notebook PC). FIGS. 11A and 11B show the configuration in which the HDD 24 is at a level higher than the printed board 70 of a notebook PC, but the lower face of the HDD 24 is not sufficiently covered with the printed board 70 of the notebook PC (only a part of the bottom of the HDD 24 is above the printed board 70).

When the HDD 24 and the printed board 70 of the notebook PC are in the above-mentioned arrangement configuration, the above-mentioned shield configuration explained in the [Shield Configuration (I) of the HDD] can be applied.

[B]

If there are a number of grounds on the surface layer of the printed board of the notebook PC directly above the substrate face of the HDD although the HDD and the printed board of the notebook PC are arranged and configured as described above in [A], there is the possibility that the influence of the radiation noise reaches on the substrate face of the HDD.

FIG. 12 is an explanatory view of the radiation noise reflected by the ground, further reflected by the ground of the surface layer of the printed board of a notebook PC when the ESD test is conducted with the above-mentioned arrangement configuration, and the influence of the reflected radiation noise on the substrate face of the HDD.

The ESD simulator 30 is allowed to contact the connector 22 of the notebook PC 20 to generate the radiation noise 32 from the ESD simulator 30. The radiation noise 32 is reflected by the horizontal coupling plate 13 (ground), further reflected by the ground 70G of the surface layer of the printed board 70 of the notebook PC 20, and is input to the substrate face 24K of the HDD 24. In this case, the substrate face 24K of the HDD 24 can receive the influence of the radiation noise 32. In this case, the HDD is shielded with the [Shield Configuration (II) of the HDD] described below.

[Shield Configuration (II) of the HDD]

Described below is the shield configuration of the HDD with the arrangement configuration as described in [B] above (FIG. 12).

When there is no flexible printed circuit (when no flexible printed circuit is connected to the connector of the HDD):
a) When the substrate face of the HDD faces the ground side:

FIG. 13 is an explanatory view showing the shield configuration in the arrangement when there is no flexible printed circuit, and the substrate face of the HDD faces the ground side.

FIGS. 13A and 13B are the perspective view and the sectional view of the above-mentioned arrangement.

In this case, as shown in FIG. 13C, the entire substrate face 24K of the HDD 24 is shielded by a Π-shaped shielding material 43 to shield the substrate face 24K of the HDD 24 to protect radiation noise.
b) When the FG face of the HDD faces the ground side:

FIG. 14 is an explanatory view showing the shield configuration in the arrangement when there is no flexible printed circuit, and the FG face of the HDD faces the ground side.

FIGS. 14A and 14B are the perspective view and the sectional view of the above-mentioned arrangement.

In this case, as shown in FIG. 14C, the entire substrate face 24K of the HDD 24 is shielded by a Π-shaped shielding material 44 to shield the substrate face 24K of the HDD 24 to protect radiation noise.

When there is a flexible printed circuit (when the flexible printed circuit is connected to the connector of the HDD):
a) When the substrate face of the HDD faces the ground side:
i) When the flexible printed circuit is on the substrate face side of the HDD:

FIG. 15 is an explanatory view showing the shield configuration in the arrangement in which there is a flexible printed circuit and the flexible printed circuit is on the substrate face side of the HDD, and the substrate face of the HDD faces the ground side.

FIGS. 15A and 15B are respectively a perspective view and the sectional view of the above-mentioned arrangement. As shown in FIGS. 15A and 15B, the flexible printed circuit 50 is bent in the longitudinal direction below the substrate face side 24K of the HDD 24, and furthermore bent toward right side of the HDD 24 at the substantially central portion below the HDD 24. One end of the flexible printed circuit 50 runs over the bottom of the HDD 24 (FIG. 15A).

In this case, as shown in FIG. 15C, the flexible printed circuit 50 is configured such that the ground layer 50G can be on the ground side. As shown in FIG. 15D, an L-shaped shielding material 41 is arranged such that the entire substrate face 24K of the HDD 24 can be covered with the face (ground layer) of the flexible printed circuit 50 and the L-shaped shielding material 45. It is desired that the superposed portion (noncontact to each other) of the L-shaped shielding material 45 and the ground layer 50G of the flexible printed circuit 50 can be sufficiently reserved.
ii) When the flexible printed circuit is on the FG face of the HDD:

FIG. 16 is an explanatory view showing the shield configuration in the arrangement in which there is a flexible printed circuit and the flexible printed circuit is on the FG face side of the HDD, and the substrate face of the HDD faces the ground side.

FIGS. 16A and 16B are respectively a perspective view and the sectional view of the above-mentioned arrangement.

As shown in FIGS. 16A and 16B, the flexible printed circuit 50 is bent in the longitudinal direction above the substrate face side of the HDD 24, and furthermore bent toward right side of the HDD 24 at the substantially central portion above the HDD 24. One end of the flexible printed circuit 50 runs over the top of the HDD 24 (FIG. 16A).

In this case, as shown in FIG. 16D, the flexible printed circuit 50 is configured such that the ground layer 50G can be opposite the ground side. (The signal layer 50S faces the substrate face 24K of the HDD 24). As shown in FIG. 16C, a Π-shaped shielding material 46 is provided to cover the entire substrate face 24K of the HDD 24. The superposed portions (noncontact to each other) of the shielding material 46 and the HDD 24 is sufficiently reserved.
b) When the FG face of the HDD faces the ground side:
i) When the flexible printed circuit is on the substrate face side of the HDD:

FIG. 17 is an explanatory view showing the shield configuration in the arrangement in which there is a flexible printed circuit and the flexible printed circuit is on the substrate face side of the HDD, and the FG face of the HDD faces the ground side.

FIGS. 17A and 17B are respectively a perspective view and the sectional view of the above-mentioned arrangement.

As shown in FIGS. 17A and 17B, the flexible printed circuit 50 is bent in the longitudinal direction above the substrate face side 24K of the HDD 24, and furthermore bent toward right side of the HDD 24 at the substantially central portion above the HDD 24. One end of the flexible printed circuit 50 runs over the top of the HDD 24 (FIG. 17A).

In this case, as shown in FIG. 17D, the flexible printed circuit 50 is configured such that the ground layer 50G can be opposite the ground side. (The signal layer 50S faces the substrate face 24K of the HDD 24). As shown in FIG. 17C, the face (ground layer) of the flexible printed circuit 50 and a shielding material 47 cover substantially the entire substrate face 24K of the HDD 24. The superposed portions (noncontact to each other) of the shielding material 47 and the flexible printed circuit 50 is sufficiently reserved.
ii) When the flexible printed circuit is on the FG face side of the HDD:

FIG. 18 is an explanatory view showing the shield configuration in the arrangement in which there is a flexible printed circuit and the flexible printed circuit is on the FG face side of the HDD, and the FG face of the HDD faces the ground side.

FIGS. 18A and 18B are respectively a perspective view and the sectional view of the above-mentioned arrangement.

As shown in FIGS. 18A and 18B, the flexible printed circuit 50 is bent in the longitudinal direction below the FG face side 24 of the HDD 24, and furthermore bent toward right side of the HDD 24 at the substantially central portion below the HDD 24. One end of the flexible printed circuit 50 runs over the bottom of the HDD 24 (FIG. 18A).

In this case, as shown in FIG. 18D, the flexible printed circuit 50 is configured such that the ground layer 50G can be on the ground side. As shown in FIG. 18C, a Π-shaped shielding material 48 is provided to cover substantially the entire substrate face 24K of the HDD 24.

[C]

When the HDD is at a level higher than the printed board of a notebook PC, and the entire bottom of the HDD is sufficiently covered by the printed board:

FIG. 19 is a schematic chart showing the arrangement in which the HDD is at a level higher than the printed board of a notebook PC, and the entire bottom of the HDD is sufficiently covered by the printed board.

FIGS. 19A and 19B are respectively a perspective view and the sectional view of the above-mentioned arrangement.

In the above-mentioned arrangement, regardless of the sides of the substrate face 24K of the HDD 24, presence/absence of the flexible printed circuit 50, and the configurations of the flexible printed circuit 50, it is not necessary to shield the substrate face 24K of the HDD 24. That is, no shielding material is required.

Conventionally, as described above, a airtight shielded enclosure is commonly used to store an HDD. On the other hand, according to the present invention, when no shield is required for the HDD, a conventionally used airtight shielded enclosure is not required, thereby reducing the total cost of the shielded enclosure. Furthermore, although a shielding material is required, the Π-shaped shielding material or an L-shaped shielding material can be used whose cost is less expensive than that of the conventional long box shaped shielded enclosure. Therefore, as compared with the case in which the HDD is used with the airtight shielded enclosure, the production cost per notebook PC can be reduced. For example, when an aluminum case is used as the above-mentioned airtight shielded enclosure, the cost-reducing effect of about 85 yen can be attained. Since a notebook PC is a product of small profits and quick returns, the cost-reducing effect is very significant in reserving sales profits from notebook PCs.

Table 1 below shows a measurement comparison result on ESD tolerance in an ESD immunity test in a case that a conventional airtight aluminum case is used and the embodiment of the present invention is applied to a product of A of an HDD manufacturer and a product of B of another HDD manufacturer.

TABLE 1

| | | PRODUCT OF HDD | | PRODUCT OF HDD | |
|---|---|---|---|---|---|
| | | MANUFACTURER A | | MANUFACTURER B | |
| | | | PRESENT | | PRESENT |
| TYPE OF HDD | | CONVENTIONAL | EMBODIMENT | CONVENTIONAL | EMBODIMENT |
| | TANDEM USB | ±9 kV | ±9 kV | ±9 kV | ±9 kV |
| | CONNECTOR (UPPER) | | | | |
| | TANDEM USB | ±9 kV | ±9 kV | ±9 kV | ±9 kV |
| | CONNECTOR (LOWER) | | | | |
| | RIGHT SCREW | ±9 kV | ±9 kV | ±9 kV | ±9 kV |
| PORTIONS | LEFT SCREW | ±9 kV | ±9 kV | ±9 kV | ±9 kV |
| TO WHICH | SCREW INSIDE HDD | ±9 kV | ±9 kV | ±9 kV | ±9 kV |
| ESD IS | SCREW OUTSIDE HDD | ±9 kV | ±9 kV | ±9 kV | ±9 kV |
| APPLIED | SCREW INSIDE | ±9 kV | ±9 kV | ±9 kV | ±9 kV |
| | DIMM COVER | | | | |
| | SCREW OUTSIDE | ±9 kV | ±9 kV | ±9 kV | ±9 kV |
| | DIMM COVER | | | | |
| | SCRWE BELOW FAN | ±9 kV | ±9 kV | ±9 kV | ±9 kV |

In Table 1, the voltage value with ± at the application point indicates the tolerance accepted in the ESD test.

As shown in Table 1, the present embodiment indicates almost the same ESD tolerance as the conventional airtight aluminum case.

In the above-mentioned embodiment, a shielding material is, for example, thin metal film of aluminum, nickel, etc.

In the embodiment, the present invention is applied to a shield of a built-in HDD in a notebook PC, but the present invention is not limited to this application, but can be applied to a shield against the ESD of an HDD equipped in another electronic devices.

The present invention can also be applied to a shield against the ESD of a mobile music player containing a small HDD and a built-in HDD in thin, light, and small equipment such as a mobile phone, a mobile terminal, etc. which is to contain a very small HDD in the future.

What is claimed is:

1. Electronic equipment containing a hard disk, comprising:
a substrate face of the hard disk provided on a ground side; and
a shielding material to shield the substrate face of the hard disk.

2. The equipment according to claim 1, wherein
a flexible printed circuit is not connected to a connector of the hard disk.

3. The equipment according to claim 1, wherein:
a flexible printed circuit is connected to a connector of the hard disk; and
the flexible printed circuit is provided on a frame ground face side of the hard disk.

4. The equipment according to claim 1, wherein
a printed board is provided directly above a substrate face of the hard disk.

5. The equipment according to claim 1, further comprising
a flexible printed circuit connected to a connector of the hard disk, and provided on the substrate face side of the hard disk.

6. The equipment having a shield configuration of a hard disk according to claim 5, wherein:
a ground layer of the flexible printed circuit is provided on a ground side; and
the substrate face of the hard disk is covered with the ground layer of the flexible printed circuit and the shielding material.

7. The equipment according to claim 1, further comprising:
a flexible printed circuit connected to the connector of the hard disk; and
a printed board provided directly above the substrate face of the hard disk.

8. The equipment according to claim 7, wherein:
the flexible printed circuit is provided on the substrate face side of the hard disk;
a ground layer of the flexible printed circuit is provided on a ground side; and
the substrate face of the hard disk is covered with the ground layer of the flexible printed circuit and the shielding material.

9. The equipment according to claim 7, wherein:
the flexible printed circuit is provided on a frame ground face side of the hard disk;
a ground layer of the flexible printed circuit is provided opposite a ground side; and
the substrate face of the hard disk is covered with a shielding material.

10. Electronic equipment containing a hard disk, comprising:
a printed board provided directly above the substrate face of the hard disk;
a frame ground face of the hard disk facing a ground side; and
a shielding material shielding the substrate face of the hard disk.

11. The equipment according to claim 10, further comprising
a flexible printed circuit connected to a connector of the hard disk, and provided on the substrate face side of the hard disk, wherein:
a ground layer of the flexible printed circuit is provided on a ground side; and
the substrate face of the hard disk is covered with the flexible printed circuit and the shielding material.

12. The equipment according to claim 10, further comprising
a flexible printed circuit connected to the connector of the hard disk, and provided on a frame ground face side of the hard disk; and
a ground layer of the flexible printed circuit is provided on a ground side.

13. The equipment according to claim 10, further comprising
a flexible printed circuit connected to a connector of the hard disk, and provided on the substrate face side of the hard disk, wherein:
a ground layer of the flexible printed circuit is provided opposite a ground side; and
the substrate face of the hard disk is covered with the flexible printed circuit and the shielding material.

14. Electronic equipment containing a hard disk, comprising
a flexible printed circuit connected to the connector of the hard disk, and provided on a frame ground face side of the hard disk, wherein:
the frame ground side of the hard disk is provided on a ground side; and
a ground layer of the flexible printed circuit is provided on the ground side.
